(19) United States
(12) Patent Application Publication
(10) Pub. No.: US 2021/0339645 A1
(43) Pub. Date: Nov. 4, 2021

(54) INDUCTIVE CHARGING SYSTEM AND POSITIONING METHOD

(71) Applicant: AUDI AG, Ingolstadt (DE)

(72) Inventors: Matthias HARDT, Neubiberg (DE); Dominik MÜLLER, Donauwörth (DE); Bianca EHN, Ingolstadt (DE)

(73) Assignee: AUDI AG, Ingolstadt (DE)

(21) Appl. No.: 17/280,615

(22) PCT Filed: Sep. 5, 2019
(86) PCT No.: PCT/EP2019/073655

§ 371 Date: Mar. 26, 2021

(30) Foreign Application Priority Data
Oct. 10, 2018 (DE) 10 2018 217 294.3

(51) Int. Cl. B60L 53/38; B60L 53/66; B60L 53/126; B60L 53/37

(52) U.S. Cl. CPC B60L 53/38; B60L 53/66; B60R 1/00; B60L 53/37; B60L 53/126

(57) ABSTRACT

A method for positioning an electric vehicle over a charging plate for inductive charging of a high-voltage storage device of an electric vehicle and to a device suitable for the method.

### DESCRIPTION

The invention relates to a method for positioning an electric vehicle above a charging plate for inductive charging of a high-voltage storage device of an electric vehicle and to a device suitable for the method.

Contactless energy transfer can be used to charge electrical energy storage devices in motor vehicles, in which energy is inductively transferred from a charging plate external to the vehicle using a primary coil installed in the floor to a secondary coil internal to the vehicle. The use of charging plates is very convenient for users of the motor vehicle, since in this case all that is required to charge the motor vehicle is to move the motor vehicle into a correct position relative to the charging plate in order to enable the motor vehicle to be charged. Additional cable connections or the like are not required.

In order to enable efficient energy transfer in the case of contactless charging of an energy store, to achieve a sufficiently high degree of efficiency, and to avoid possible damage to the motor vehicle due to reactive currents, the motor vehicle has to be positioned very precisely above the charging plate. Since the primary coil has to be positioned under the motor vehicle, the user of the motor vehicle, that is to say the driver of the vehicle, may find it difficult under certain circumstances to position the motor vehicle correctly because he cannot see the primary coil when maneuvering the motor vehicle.

Different approaches are currently being discussed as to how the vehicle can find its suitable position above the charging plate. For example, methods are discussed which use an electromagnetic signal for positioning (e.g., LPE, LF, MV according to IEC 61980-2). This signal is very susceptible to interference and requires remote sensors, which have to be installed in the underbody region or on the bumper of the motor vehicle. Optical systems for positioning that work with parking space markings have also been studied.

DE 10 2014 016 031 A1 discloses a charging plate for contactless charging of an energy storage device of a motor vehicle and a method for positioning a motor vehicle in a charging position. The charging plate comprises a marking element which is detected by a camera on the motor vehicle.

DE 10 2014 223 237 A1 discloses an inductive charging system for charging an electric vehicle, which comprises a primary coil that is arranged on a floor surface and has a stationary marking element which is detected using a camera of the electric vehicle.

DE 10 2014 201 821 A1 discloses a charging device having a positioning aid. The charging device comprises a charging current receiving element on the vehicle and a charging current delivery element for the inductive transmission of energy to the charging current receiving element, wherein light-emitting diodes mark the charging current delivery element by means of a light cone having different colors and the light cone is detected by a camera on the vehicle.

All approaches presented so far show deficits in terms of their robustness and their interoperable application possibilities. Due to the influences of the different environmental conditions, a complex calibration is necessary, which nevertheless cannot preclude temporary influences due to electronic devices in the environment.

Against this background, the invention has the object of providing a device and a method which at least partially eliminate the disadvantages of the prior art.

The object is achieved by a method having the features of claim 1, a charging system having the features of claim 6, and a motor vehicle having the features of claim 9 and a charging plate having the features of claim 10. Embodiments of the invention result from the dependent claims.

The subject matter of the invention is a method for positioning a motor vehicle in a charging position suitable for contactless charging of an energy storage device of the motor vehicle According to the invention, for positioning the motor vehicle on a charging plate arranged on a floor surface, which is part of of a charging station comprising at least one charging plate, at least one light source is used, which is installed in the charging plate so it is safe to drive over and is configured to emit amplitude-modulated and/or frequency-modulated light signals. In one embodiment, at least one light-emitting diode (LED) is used as the light source. In a special embodiment, at least one infrared LED is used. This has the advantage that the light-emitting diodes can be recognized using weak infrared absorption even in the dark and/or when soiled. The embodiment in which infrared light is generated has the additional advantage that the infrared light source can also act as a heating element so that, for example, when the light source is covered by snow, it can be melted away.

In one embodiment of the method, communication is first established between the motor vehicle and an infrastructure of the charging station. In one embodiment, the communication between the motor vehicle and the infrastructure of the charging station takes place via WLAN, Bluetooth, or cellular radio. For example, data for identifying the vehicle and the required charging configuration can be transmitted via standardized WLAN or Bluetooth communication between the vehicle and the charging infrastructure.

The at least one light source of at least one presently available charging plate of the charging station thereupon emits an individually coded, amplitude-modulated and/or frequency-modulated light signal. In the context of the present invention, amplitude modulation means a variation of the intensity of the light signal, that is to say of the brightness. For example, a sequence of light pulses can be generated in which both the duration of the individual light pulses and also their spacing can be variable. In the context of the present invention, frequency modulation means a variation of the wavelength of the light signal, that is to say of the color of the light. The light signals can thus comprise light of different colors in order to encode information. Continuous or discontinuous transitions between different wavelengths can also take place within the light signal.

The positioning concept according to the invention is based on the use of the optical signals which are emitted by at least one light source installed on the charging plate, for example one or more LEDs, and are used both as the respective direction finding signal and also for point-to-point communication between the vehicle and the charging plate. In one embodiment of the method, after communication has been established between the vehicle and the charging infrastructure, all charging plates that are potentially available to the vehicle each begin to emit an individual flashing code and/or color code. The code of the individual charging plates can be individually changed dynamically. Both the code of a single LED signal and also the code of all LED signals of a charging plate can be changed.

The individually coded, amplitude-modulated and/or frequency-modulated light signal is detected by a sensor device of the motor vehicle. A camera of the motor vehicle, in particular a wide-angle camera, which is preferably installed in the rear or front region of the motor vehicle, can be used as the sensor device. The camera can in particular be installed in the region of a bumper. In particular, a region directly adjacent to the motor vehicle and in front of or behind the motor vehicle can be detected by the sensor device. In one embodiment, the sensor device of the motor vehicle therefore comprises at least one camera, in particular a front camera installed in the front vehicle region. Motor vehicles often already comprise one or more cameras for surroundings detection. In particular, wide-angle cameras can be provided on motor vehicles, which image the vehicle surroundings directly adjacent to the motor vehicle at a wide angle. Corresponding cameras are used, for example, in top view systems or in the context of parking assistance.

The detected light signals are detected and evaluated via cameras installed in the vehicle. In one embodiment, the light signals are detected via a front camera installed in the front vehicle region. Using the information about the installation location of the individual LEDs, the relative position of the vehicle can be determined. In addition, further information can be transmitted from the charging plate to the vehicle via modulation of the LED signals in the time domain (pulsing or switching on and off) and in the frequency domain (color changes).

This has the advantage that the signal is not interfered with by special ambient conditions. A possible restriction of the visibility of the signals is seen as acceptable and can be compensated for by redundancy, i.e., the use of several LEDs. An improvement by the use of infrared LEDs can also be achieved in this context. This problem is also unimportant if it is predominantly used in a sheltered region.

The coding and position of the light signal are then evaluated in a control unit of the motor vehicle, a currently available charging plate is selected, and a trajectory of the motor vehicle is determined from the current position into the charging position of the selected charging plate. The motor vehicle is then guided into the charging position by a control device of the motor vehicle by triggering at least one driving instruction to a driver of the motor vehicle and/or at least one longitudinal and/or transverse driving intervention. The vehicle or the driver recognizes the LED signals and can thus navigate onto the charging plate. In one embodiment, the result of the evaluation is used for a supplementary display. In one variant, a camera image having corresponding auxiliary lines is displayed to the driver, so that manual maneuvering is assisted by the camera image. Various vehicle systems, in particular actuators, in the motor vehicle, which are associated with the brakes, the steering, and/or the engine of the motor vehicle, for example, can be activated by the control device to trigger driving interventions. Outputting driving instructions and carrying out driving interventions to guide the motor vehicle to a predetermined position are known in principle in the prior art and are not to be explained in detail.

In addition, the motor vehicle reports back information about the selected charging plate and the charging requirements of the vehicle to the infrastructure of the charging station via the communication path. The charging structure can thus unambiguously assign the vehicle to the charging plate that has been approached. This assignment is necessary in order to relay charging requirements of the vehicle to the corresponding charging plate.

The subject matter of the invention is also a device suitable for carrying out the method according to the invention.

The subject matter of the invention is an inductive charging system for charging an energy storage device of a motor vehicle. The charging is carried out by means of a stationary charging station, wherein the charging station comprises at least one charging plate arranged on a floor surface having a primary coil for generating an alternating magnetic field and the motor vehicle has a secondary coil for receiving the alternating magnetic field. The primary coil induces a charging voltage in the secondary coil by generating an alternating magnetic field. A predetermined parking position of the motor vehicle above the charging plate is provided for receiving the alternating magnetic field. In the parking position, in particular, an efficiency of the energy transfer from the primary coil to the secondary coil is greater than a predetermined minimum value.

The charging system comprises two components, namely a charging station having at least one charging plate and at least one motor vehicle.

According to the invention, each charging plate has at least one light source installed in the charging plate so that it is safe to drive over and configured to emit amplitude-modulated and/or frequency-modulated light signals, and the motor vehicle has at least one sensor device for detecting amplitude-modulated and/or frequency-modulated light signals from the at least one light source.

In one embodiment, the at least one light source comprises at least one light-emitting diode. In a special embodiment, the light-emitting diodes are colored light-emitting diodes whose overall spectrum (i.e., their color) can be adjusted to different connections by control signals or a corresponding allocation of a control current.

In one embodiment of the charging system, the at least one light source generates infrared light and the at least one sensor device has a sensor for infrared light. In a further embodiment, the at least one sensor device comprises at least one camera.

In one embodiment, the at least one charging plate has multiple light sources configured to emit amplitude-modulated and/or frequency-modulated light signals, for example two, three, or four light sources. In one embodiment, the outline of the at least one charging plate has the shape of a polygon, for example a triangle, a rectangle, a hexagon, or an octagon. In one embodiment, the polygon has at least one light source installed so it is safe to drive over and configured to emit amplitude-modulated and/or frequency-modulated light signals at each of its corners. The light sources assist the positioning of the motor vehicle in the parking position. In one embodiment, the light sources are controlled by a controller in the charging plate depending on the application.

The at least one motor vehicle is preferably designed as an automobile, in particular as a passenger vehicle or truck, or as a passenger bus or motorcycle.

The at least one motor vehicle has a secondary coil for receiving the alternating magnetic field. In one embodiment, the motor vehicle comprises at least one camera for generating camera images of the surroundings of the motor vehicle, for example a front camera installed in the front region of the vehicle, and at least one display device for reproducing camera images, i.e., for example a display screen, as well as a module configured for wireless communication with the charging station, which is configured for communication between the vehicle and the charging infrastructure, for example a WLAN or Bluetooth communication module or a cellular radio module. A vehicle-to-infrastructure communication module, also known as car-to-X technology, can also be provided. For example, data can be exchanged between the charging station and the motor vehicle when the charging station is reached or approached.

In one embodiment, the at least one motor vehicle comprises an image processing device which is configured to overlay auxiliary lines in the displayed camera images, which assist the navigation along a calculated trajectory. The image processing device can be provided, for example, by a processor device, as can be provided by an information/entertainment system (infotainment system) or a control device of the motor vehicle.

In a further embodiment, the image processing device is designed to convert the camera images into transformed images by means of homography. A top view or bird's eye view of the surroundings is generated by means of the homography. In other words, the camera images are distorted in perspective. In the transformed camera images, the surroundings are shown as a top view, as if the at least one camera were not located in the motor vehicle, but above the motor vehicle, and an optical axis of the at least one camera were directed downwards towards the motor vehicle and the surroundings. In this embodiment, the image processing device is also designed to display these transformed camera images on the display device as the displayed camera images. This embodiment has the advantage that the display plane of the transformed camera images corresponds to the movement plane in which the user can maneuver the motor vehicle. In other words, the movements of the motor vehicle correspond to the movements of the light sources imaged in the transformed camera images.

The invention provides an inductive charging system which enables a vehicle to be positioned for the charging process easily, precisely, and insensitive to interfering influences of the surroundings, which are caused by electronic devices, for example. For the charging system, already known components, which are already present in many motor vehicles in particular, can be used for cost-effective implementation.

Further advantages and embodiments of the invention will be apparent from the description. It is apparent that the above-mentioned features are usable not only in the particular specified combination but rather also in other combinations or alone, without leaving the scope of the present invention.

1-10. (canceled)

11. A method for positioning a motor vehicle in a charging position suitable for contactless charging of an energy storage device of the motor vehicle, wherein, for positioning the motor vehicle on a charging plate arranged on a floor surface, which is part of a charging station comprising at least one charging plate, at least one light source is used, which is installed in the charging plate so it is safe to drive over and is configured to emit amplitude-modulated and/or frequency-modulated light signals.

12. The method according to claim 11, wherein communication is first established between the motor vehicle and an infrastructure of the charging station, whereupon at least one presently available charging plate of the charging station emits an individually coded, amplitude-modulated and/or frequency-modulated light signal, which is detected by a sensor device of the motor vehicle, after which the coding and position of the light signal is evaluated in a control unit of the motor vehicle, a presently available charging plate is selected, and a trajectory of the motor vehicle is determined from the present position into the charging position of the selected charging plate, after which the motor vehicle is guided into the charging position by a control device of the motor vehicle by triggering at least one driving instruction to a driver of the motor vehicle and/or at least one longitudinal and/or transverse driving intervention, and the motor vehicle reports information about the selected charging plate and the charging requirements of the vehicle to the infrastructure of the charging station.

13. The method according to claim 11, wherein at least one light-emitting diode (LED) is used as the light source, in particular at least one infrared LED.

14. The method according to claim 12, wherein the communication between the motor vehicle and the infrastructure of the charging station takes place via WLAN, Bluetooth, or cellular radio.

15. The method according to claim 12, wherein the sensor device of the motor vehicle comprises at least one camera, in particular a front camera installed in the front region of the vehicle.

16. An inductive charging system for charging an energy storage device of a motor vehicle by means of a stationary charging station, wherein the charging station has at least one charging plate arranged on a floor surface having a primary coil for generating an alternating magnetic field and the motor vehicle has a secondary coil for receiving the alternating magnetic field, wherein a predetermined parking position of the motor vehicle above the charging plate is provided for the receiving, wherein the charging plate has at least one light source which is installed in the charging plate so that it is safe to drive over and is configured to emit amplitude-modulated- and/or frequency-modulated light signals, and the motor vehicle has at least one sensor device for detecting amplitude-modulated and/or frequency-modulated light signals of the at least one light source.

17. The charging system of claim 16, wherein the at least one light source generates infrared light and the at least one sensor device comprises a sensor for infrared light.

18. The charging system according to claim 16, wherein the at least one sensor device comprises at least one camera.

19. A motor vehicle for a charging system according to claim 16, which has at least one camera for generating camera images of the surroundings of the motor vehicle and at least one display device for reproducing camera images, as well as a module configured for wireless communication with the charging station.

20. A charging plate for a charging system according to claim 16, the outline of which is in the shape of a polygon, which has at least one light source installed so it is safe to drive over and configured to emit amplitude-modulated and/or frequency-modulated light signals at each of its corners.

21. The method according to claim 12, wherein at least one light-emitting diode (LED) is used as the light source, in particular at least one infrared LED.

22. The method according to claim 13, wherein the communication between the motor vehicle and the infrastructure of the charging station takes place via WLAN, Bluetooth, or cellular radio.

23. The method according to claim 13, wherein the sensor device of the motor vehicle comprises at least one camera, in particular a front camera installed in the front region of the vehicle.

24. The method according to claim 14, wherein the sensor device of the motor vehicle comprises at least one camera, in particular a front camera installed in the front region of the vehicle.

25. The charging system according to claim 17, wherein the at least one sensor device comprises at least one camera.
